(19) United States
(12) Patent Application Publication
(10) Pub. No.: US 2024/0222694 A1
(43) Pub. Date: Jul. 4, 2024

(54) MULTI-LAYER CERAMIC BATTERIES INCLUDING ALL-SOLID ELECTROLYTE AND ELECTRONIC APPARATUSES INCLUDING THE SAME

(71) Applicant: Samsung Electronics Co., Ltd., Suwon-si (KR)

(72) Inventors: Heungchan Lee, Suwon-si (KR); Taeyoung Kim, Suwon-si (KR); Jonghoon Ka, Suwon-si (KR); Jeongkuk Shon, Suwon-si (KR); Sungjin Lim, Suwon-si (KR)

(21) Appl. No.: 18/395,936

(22) Filed: Dec. 26, 2023

(30) Foreign Application Priority Data
Dec. 28, 2022 (KR) 10-2022-0187968

(51) Int. Cl. H01M 10/0562; H01M 4/75; H01M 10/6551; H01M 10/6555; H01M 50/434

(52) U.S. Cl. CPC H01M 10/0562; H01M 4/75; H01M 10/6551; H01M 10/6555; H01M 50/434

(57) ABSTRACT

A multilayer ceramic battery including a cell stack including a plurality of unit cells, a first external current collector layer disposed on a first side surface of the cell stack, a second external current collector layer disposed on a second side surface of the cell stack, a case surrounding the cell stack, the first external current collector layer, and second external current collector, and a heat dissipation layer configured to dissipate heat generated from the cell stack to the outside, wherein the heat dissipation layer is disposed in a region surrounded by the case.

### CROSS-REFERENCE TO RELATED APPLICATION

This application claims priority to and benefit of Korean Patent Application No. 10-2022-0187968, filed on Dec. 28, 2022, in the Korean Intellectual Property Office, and all the benefits accruing therefrom under 35 U.S.C. § 119, the content of which in its entirety is herein incorporated by reference.

### BACKGROUND

### 1. Field

The disclosure relates to a secondary battery, and more particularly, to a multilayer ceramic battery including an all-solid electrolyte, and an electronic apparatus including the same.

### 2. Description of the Related Art

A multi-layer ceramic battery (MLCB) may be viewed as a battery version of a multi-layer ceramic capacitor (MLCC). The MLCB may be regarded as a battery having a layer structure in which thin film oxide electrodes and oxide electrolytes are alternately stacked.

The MLCB has been based on the MLCC structure so far, and research is being conducted on various problems that may appear in a high-speed charge or discharge process for commercialization.

### SUMMARY

An embodiment provides a multilayer ceramic battery including an all-solid electrolyte capable of increasing heat dissipation efficiency during a battery operation.

An embodiment provides an electronic apparatus including the multilayer ceramic battery.

Additional aspects will be set forth in part in the description which follows and, in part, will be apparent from the description, or may be learned by practice of the presented embodiments of the disclosure.

A multilayer ceramic battery in accordance with an embodiment includes a cell stack including a plurality of unit cells, a first external current collector layer disposed on a first side surface of the cell stack, a second external current collector layer disposed on a second side surface of the cell stack, a case surrounding the cell stack, the first external current collector layer, and the second external current collector layer, and a heat dissipation layer configured to dissipate heat generated from the cell stack to the outside, wherein the heat dissipation layer is disposed in a region surrounded by the case.

In an embodiment, the heat dissipation layer may be disposed inside the cell stack.

In an embodiment, the heat dissipation layer may be disposed between the cell stack and the case. The heat dissipation layer may be disposed in a unit cell of the plurality of unit cells. The unit cell may include a first electrode layer, a second electrode layer disposed to face the first electrode layer, and an all-solid electrolyte layer disposed between the first electrode layer and the second electrode layer, wherein the heat dissipation layer may be disposed between the first electrode layer and the all-solid electrolyte layer, between the second electrode layer and the all-solid electrolyte layer, or a combination thereof.

In an embodiment, the unit cell may include a first electrode layer, a second electrode layer disposed to face the first electrode layer, and an all-solid electrolyte layer disposed between the first electrode layer and the second electrode layer, wherein the first electrode layer and the second electrode layer may be current collector layers, one of the first electrode layer and the second electrode layer may be the heat dissipation layer, and a heat release coefficient of the first electrode layer and a heat release coefficient of the second electrode layer may be different from each other.

In an embodiment, the unit cell may include a first electrode layer, a first internal current collector layer in contact with the first electrode layer, a second electrode layer disposed to face the first electrode layer, a second internal current collector layer in contact with the second electrode layer, and an all-solid electrolyte layer between the first electrode layer and the second electrode layer, and between the first internal current collector layer and the second internal current collector layer, wherein one of the first internal current collector layer and the second internal collector layer may be the heat dissipation layer, and a heat release coefficient of the first internal collector layer and a heat release coefficient of the second internal current collector layer may be different from each other. In an embodiment, only one surface of the first electrode layer may be in contact with the first internal current collector layer, and only one surface of the second electrode layer may be in contact with the second internal current collector layer. In an embodiment, the first electrode layer may be disposed on both sides of the first internal current collector layer, and the second electrode layer may be disposed on both sides of the second internal current collector layer.

In an embodiment, the unit cell may include a first electrode layer, a second electrode layer disposed to face the first electrode layer, and an all-solid electrolyte layer disposed between the first electrode layer and the second electrode layer, wherein one of the first electrode layer and the second electrode layer may include the heat dissipation layer. In an embodiment, one of the first electrode layer and the second electrode layer may include a stack including a plurality of material layers, and at least one of the plurality of material layers may be the heat dissipation layer.

In an embodiment, the multilayer ceramic battery may further include an external heat dissipation layer on an outer surface of the case. In an embodiment, a surface of the external heat dissipation layer may include a wrinkle. In an embodiment, the surface of the external heat dissipation layer may include a plurality of protrusions. In an embodiment, a portion of the external heat dissipation layer may include a first material layer, and a remaining portion of the external heat dissipation layer may include a second material layer, which is different from the first material layer.

A multilayer ceramic battery according to an embodiment includes a cell stack including a plurality of unit cells, a first external current collector layer disposed on a first side surface of the cell stack, a second external current collector layer disposed on a second side surface of the cell stack, a case surrounding the cell stack, the first external current collector, and the second external current collector, and an external heat dissipation layer disposed on an outer surface of the case, wherein the external heat dissipation layer may include a wrinkle on a surface thereof.

An electronic apparatus according to an embodiment includes a controller for controlling an operation of a device, and a battery, wherein the battery may include the multilayer ceramic battery described above. In an embodiment, the electronic apparatus may be a wearable device.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 10 are each a cross-sectional view of an embodiment of a multilayer ceramic battery including an all-solid electrolyte;

FIGS. 11 and 12 are each a cross-sectional view of an embodiment in which an electrode layer of a battery including an all-solid electrolyte has a layer structure including a plurality of layers;

FIGS. 13 and 14 are each a cross-sectional view of an embodiment of a layer structure of a unit cell of a cell stack included in a battery including an all-solid electrolyte;

FIG. 15 is a cross-sectional view of an embodiment in which an external heat dissipation layer is provided in a battery including an all-solid electrolyte;

FIG. 16 is a cross-sectional view of an embodiment in which a plurality of quadrangular pillar-shape protrusions is provided on a surface of an external heat dissipation element of the battery shown in FIG. 15 to increase a surface area of the external heat dissipation element;

FIG. 17 is a cross-sectional view of an embodiment in which a plurality of triangular pyramid-shape protrusions is provided on a surface of the external heat dissipation element of the battery shown in FIG. 15 to increase a surface area of the heat sink;

FIG. 18 is a cross-sectional view of an embodiment in which a plurality of hemispherical protrusions is provided on a surface of an external heat dissipation element of the battery shown in FIG. 15 to increase a surface area of the external heat dissipation element;

FIG. 19 is a cross-sectional view of an embodiment in which a surface of an external heat dissipation element of the battery shown in FIG. 15 has a wave structure;

FIG. 20 is a three-dimensional view of a battery replaceable wireless earbud of an embodiment of an electronic apparatus including a secondary battery;

FIG. 21 is a three-dimensional view illustrating an embodiment in which the earbud of FIG. 20 is both wired and wireless;

FIG. 22 is a three-dimensional view illustrating an embodiment in which the earbud of FIG. 20 is a built-in battery type without a slot;

FIG. 23 is a three-dimensional view showing an embodiment for storage and charging of the earbuds illustrated in FIGS. 20 to 22; and

FIG. 24 is a three-dimensional view illustrating an embodiment of a mobile apparatus for exclusive use of the earbuds shown in FIG. 20.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

Hereinafter, a multilayer ceramic battery including a solid electrolyte according to an embodiment and an electronic apparatus including the same will be described in detail with reference to the accompanying drawings. The thicknesses of layers and regions may be exaggerated for clarification of the specification.

The embodiments of the disclosure are capable of various modifications and may be embodied in many different forms. Also, when an element or layer is referred to as being “on” or “above” another element or layer, the element or layer may be directly on another element or layer or intervening elements or layers. In the following description, like reference numeral refer to like element.

The singular forms are intended to include the plural forms as well unless the context clearly indicates otherwise. In addition, it should be understood that, when a part “comprises” or “includes” an element in the specification, unless otherwise defined, it is not excluding other elements but may further include other elements.

The term “above” and similar directional terms may be applied to both singular and plural. With respect to operations that constitute a method, the operations may be performed in any appropriate sequence unless the sequence of operations is clearly described. The operations may not necessarily be performed in the order of sequence.

Also, in the specification, the term “units” or “ . . . modules” denote units or modules that process at least one function or operation, and may be realized by hardware, software, or a combination of hardware and software.

In addition, connections or connection members of lines between components shown in the drawings illustrate functional connections and/or physical or circuit connections, and the connections or connection members may be represented by replaceable or additional various functional connections, physical connections, or circuit connections in an actual apparatus.

The use of any and all examples, or exemplary language (e.g., “such as”) provided herein, is intended merely to better illuminate the disclosure and does not pose a limitation on the scope of the disclosure unless otherwise claimed.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A “multilayer ceramic battery” or “stacked battery” may refer to a battery in which two or more unit batteries are sequentially stacked in a first direction. In an embodiment, a number of unit batteries stacked in the first direction may be several, tens, or hundreds, but is not limited thereto. If a plurality of unit batteries is stacked in a vertical or substantially vertical direction on one surface of a base substrate, the first direction may be a direction perpendicular to the one surface of the base substrate. The unit battery may be expressed as a battery of a minimum size capable of performing a battery operation. In an embodiment, the unit battery may include a layer structure in which a first electrode layer, an all-solid electrolyte layer, and a second electrode layer are sequentially stacked. One of the first electrode layer and the second electrode layer may be a cathode layer, and the other may be an anode layer. In an embodiment, a material of the cathode layer may include a lithium active material, such as lithium cobalt oxide (LCO), lithium manganese oxide (LMO), lithium manganese nickel oxide (LMNO), lithium nickel-cobalt-manganese (NCM), lithium nickel cobalt aluminum oxide (NCA), lithium vanadium phosphate (LVP), etc. and a sodium active material, but is not limited thereto. In an embodiment, a material of the anode layer may include silicon (Si), carbon (C), graphite, LVP, lithium titanate (LTO), lithium, silver, or a combination thereof, but is not limited thereto. In an embodiment, the anode layer may not be present upon assembly. For example, the anode layer may include only a current collector layer without including the material of the anode layer described above. In an embodiment, a material of the all-solid electrolyte layer may include La-doped BaSnOs (LBSO), lithium aluminum titanium phosphate (LATP), lithium aluminum germanium phosphate (LAGP), lithium lanthanum titanium oxide (LLTO), lithium lanthanum zirconium oxide (LLZO), lithium lanthanum zirconium titanium oxide (LLZTO), halide derivatives, or a combination thereof, but is not limited thereto. In an embodiment, a planar shape of the first electrode layer and a planar shape of the second electrode layer may be the same as or different from each other. In an embodiment, areas of the first electrode layer and the second electrode layer when viewed on a plane may be the same as or different from each other. In an embodiment, a perimeter (e.g., circumference, or edge) of the first electrode layer and the second electrode layer when viewed on a plane may include curves, and straight lines, or may include a plurality of straight lines parallel to each other or forming an angle to each other. In an embodiment, a shape of the first electrode layer and the second electrode layer when viewed on a plane may be circular, non-circular, or polygonal.

In an embodiment, a number of side surfaces of the first electrode layer and a number of side surfaces of the second electrode layer may be the same as or different from each other. In an embodiment, each of the first electrode layer and the second electrode layer may include at least one, two, or three sides.

Therefore, a multilayer ceramic battery including such a unit battery may include two or more side surfaces (at least two side surfaces) on which an external current collector may be disposed (e.g., attached or contacted) and may have a structure in which at least two side surfaces are covered with the external current collector. Directions of the at least two side surfaces may be different from each other. For example, when viewed from a plan view, the at least two side surfaces may be in different directions. In an embodiment, the multilayer ceramic battery may have a structure configured to include at least two side surfaces facing in different directions from each other, a portion of the at least two side surfaces may be covered with a first external current collector (e.g., a cathode external current collector) and a remaining portion of the at least two side surfaces may be covered with a second external current collector (e.g., an anode external current collector). In an embodiment, a material of the external current collector (e.g., the first external current collector or the second external current collector) may include copper, aluminum, iron, an alloy thereof, or a combination thereof, or may include a conductive oxide, such as indium tin oxide (ITO) or fluorine doped tin oxide (FTO), but is not limited thereto.

In an embodiment, a shape or a size of the external current collector disposed (e.g., provided) on the side surface of the multilayer ceramic battery may vary depending on a conductivity of the anode electrode layer and the cathode electrode layer included in the multilayer ceramic battery. In an embodiment, a separate internal current collector connected to the external current collector may or may not be provided according to the conductivity of the anode electrode layer and the cathode electrode layer of the multilayer ceramic battery.

In an embodiment, the multilayer ceramic battery may include a layer configuration or a layer structure capable of increasing heat dissipation efficiency during charging and/or discharging the multilayer ceramic battery.

Hereinafter, the multilayer ceramic batteries will be described in more detail through embodiments.

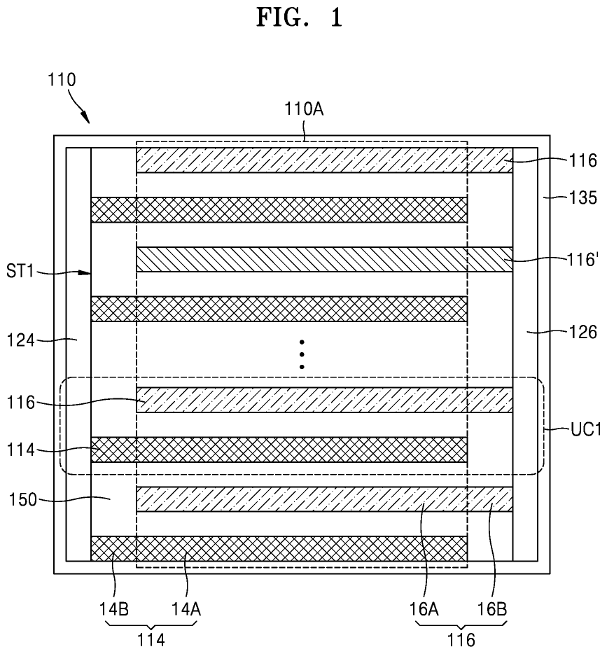

FIG. 1 shows an embodiment of a first multilayer ceramic battery 110 including an all-solid electrolyte.

Referring to FIG. 1, the first multilayer ceramic battery 110 includes a plurality of unit batteries (e.g., unit cells) UC1 sequentially stacked vertically and a first external current collector layer 124 and a second external current collector layer 126 connected thereto. The unit battery UC1 may be expressed as a unit cell. The first multilayer ceramic battery 110 includes a cell stack ST1, which includes a plurality of unit batteries UC1 sequentially stacked. That is, the plurality of unit batteries UC1 may be sequentially stacked to form a cell stack ST1.

The unit battery UC1 includes a first electrode layer 114, a second electrode layer 116, and an all-solid electrolyte layer 150 between the first electrode layer 114 and the second electrode layer 116. The first electrode layer 114 and the second electrode layer 116 may be completely separated by the all-solid electrolyte layer 150. That is, a space between the first electrode layer 114 and the second electrode layer 116 may be filled, for example, completely filled with the all-solid electrolyte layer 150. The first electrode layer 114 and the second electrode layer 116 may face each other in parallel or substantially in parallel with the all-solid electrolyte layer 150 therebetween.

In an embodiment, the first electrode layer 114 and the second electrode layer 116 may include a material layer having conductivity sufficient to function as a current collector. Accordingly, the first electrode layer 114 and the second electrode layer 116 may be both electrode layers and internal current collector layers. One of the first electrode layer 114 and the second electrode 116 may be a cathode layer and the other may be an anode layer.

The first electrode layer 114 includes a first portion 14A included in a main region 110A, which is a region where charging and discharging directly occurs, and a second portion 14B connecting the main region 110A and the first external current collector layer 124. The second electrode layer 116 also includes a first portion 16A included in the main region 110A and a second portion 16B contacting the second external current collector layer 126. The first portion 14A of the first electrode layer 114 and the first portion 16A of the second electrode layer 116 may be disposed to entirely overlap with each other. Main region herein does not necessarily mean larger region. In an aspect, the main region is an active region. The main region can be bordered by a peripheral region and can be smaller or larger than the peripheral region.

Dividing each of the first electrode layer 114 and the second electrode 116 into two parts is merely for convenience of explanation and is not intended to suggest that the electrode layers are physically separated or divided.

Some of the plurality of second electrode layers 116 included in the cell stack ST1 may be both current collectors and heat dissipation layers. That is, a selected second electrode layer 116′ of the second electrode layers 116 included in the cell stack ST1 may serve as an electrode layer, a current collector layer, and a heat dissipation layer. In other words, the selected second electrode layer 116′ may be the electrode layer, the current collector layer, and simultaneously the heat dissipation layer. Accordingly, a material of the selected second electrode layer 116′ may be different from that of the other second electrode layers 116. In an embodiment, the material of the selected second electrode layer 116′ may include Al₂O₃, BN, Si₂N₄, SiO₂, AlN, MgO, carbon, silicon carbide, glass, a metal, or a combination thereof.

For convenience, the selected second electrode layer 116′ may be expressed as a second electrode layer 116′ for heat dissipation or a second heat dissipation electrode layer 116′.

In FIG. 1, although the cell stack ST1 is illustrated as including one second heat dissipation electrode layer 116′, two or more second heat dissipation electrode layers 116′ may be included. However, a number of the second heat dissipation electrode layers 116′ may be limited within a range that does not break a balance between heat dissipation efficiency and current collection efficiency of the multilayer ceramic battery or within a range that maintains a set current collection efficiency of the multilayer ceramic battery.

The first external current collector layer 124 may be provided to cover a first side surface of the cell stack ST1, and the second external current collector layer 126 may be provided to cover a second side surface of the cell stack ST1. The first and the second side surfaces of the cell stack ST1 may face each other in parallel or may be inclined to each other.

Reference numeral 135 in FIG. 1 denotes a battery case.

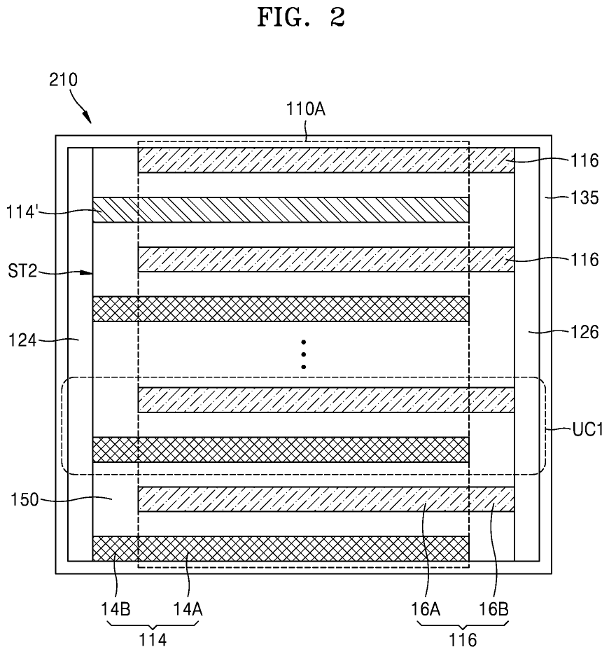

FIG. 2 shows an embodiment of a second multilayer ceramic battery 210 including an all-solid electrolyte. Only parts different from those of the first multilayer ceramic battery 110 of FIG. 1 will be described.

Referring to FIG. 2, the second multilayer ceramic battery 210 includes a second cell stack ST2 including a plurality of unit batteries UC1 sequentially stacked. Some of the plurality of first electrode layers 114 included in the second cell stack ST2 may be current collectors and heat dissipation layers. That is, a selected first electrode layer 114′ of the first electrode layers 114 included in the second cell stack ST2 may serve as an electrode layer, a current collector layer, and a heat dissipation layer. That is, the selected first electrode layer 114′ may be the electrode layer, the current collector layer, and the heat dissipation layer, simultaneously. Therefore, a material of the selected first electrode layer 114′ may be different from a material of the other first electrode layers 114. In an embodiment, the material of the selected first electrode layer 114′ may include Al₂O₃, BN, Si₂N₄, SiO₂, AlN, MgO, carbon, silicon carbide, glass, a metal, or a combination thereof.

Similar to the selected second electrode layer 116′, the selected first electrode layer 114′ may be expressed as a first heat dissipation electrode layer 114′.

In FIG. 2, although the second cell stack ST2 is illustrated as including one first heat dissipation electrode layer 114′, two or more first heat dissipation electrode layers 114′ may be included. However, a number of the first heat dissipation electrode layers 114′ may be limited within a range that does not break the balance between heat dissipation efficiency and current collection efficiency of the multilayer ceramic battery or within a range that maintains the set current collection efficiency of the multilayer ceramic battery.

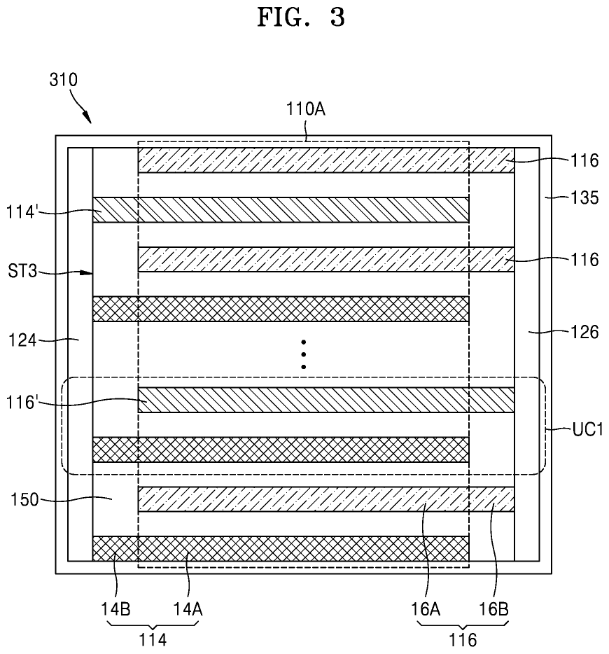

FIG. 3 shows an embodiment of a third multilayer ceramic battery 310 including an all-solid electrolyte. Only parts different from the first and the second multilayer ceramic batteries 110 and 210 will be described.

As shown in FIG. 3, a third cell stack ST3 of the third multilayer ceramic battery 310 includes both the first heat dissipation electrode layer 114′ and the second heat dissipation electrode layer 116′. A number of the first and the second heat dissipation electrode layers 114′ and 116′ included in the third cell stack ST3 may be limited within a range that does not break the balance between heat dissipation efficiency and current collection efficiency of the multilayer ceramic battery or within a range that maintains a set current collection efficiency of the multilayer ceramic battery. In an embodiment, in the third cell stack ST3, the number of the first heat dissipation electrode layers 114′ may be the same as or different from the number of the second heat dissipation electrode layers 116′.

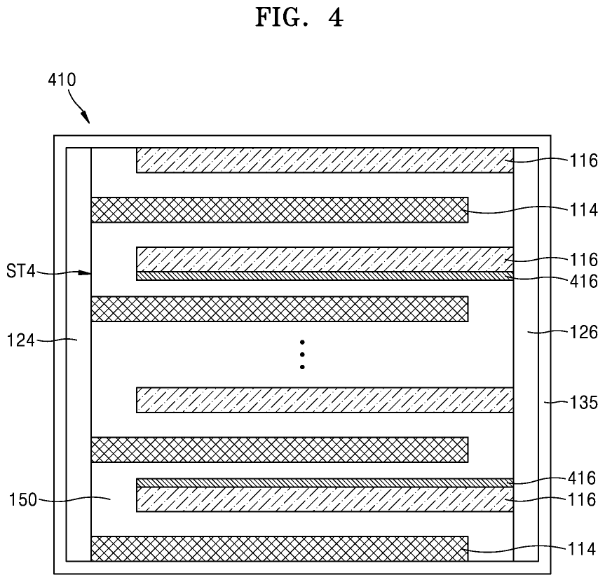

FIG. 4 shows an embodiment of a fourth multilayer ceramic battery 410 including an all-solid electrolyte. Only parts different from those of the first to the third multilayer ceramic batteries 110, 210, and 310 will be described.

As shown in FIG. 4, a fourth cell stack ST4 of the fourth multilayer ceramic battery 410 has a separate first heat dissipation layer 416 on a surface of the second electrode layer 116 instead of having a heat dissipation electrode layer. Accordingly, in the fourth cell stack ST4, each first electrode layer of the plurality of first electrode layers 114 may include the same material with one another, and each second electrode layer of the plurality of second electrode layers 116 may include the same material with one another. In an aspect, the first heat dissipation layer 416 may be disposed on an upper surface of the second electrode layer 116, or on an opposite lower surface of the second electrode layer 116.

In an embodiment, the first heat dissipation layer 416 may be provided to cover a portion or an entirety of the upper surface or the lower surface of the second electrode layer 116 facing the first electrode layer 114. In an aspect, the first heat dissipation layer 416 may face the first electrode layer 114 of the same unit cell. In an aspect, the first heat dissipation layer 416 may face the first electrode layer 114 of an adjacent unit cell. The first heat dissipation layer 416 may be provided in direct contact with the upper surface or the lower surface of the second electrode layer 116. In an embodiment, a thickness of the first heat dissipation layer 416 may be the same as or different from a thickness of the second electrode layer 116. In an embodiment, the material of the first heat dissipation layer 416 may include Al₂O₃, BN, Si₂N₄, SiO₂, AlN, MgO, SiC, C, glass, a metal, or a combination thereof. Because the first heat dissipation layer 416 is inside the fourth cell stack ST4, it may also be referred to as an internal heat dissipation layer.

In an embodiment, in the fourth cell stack ST4, two or more first heat dissipation layers 416 may be provided, but a number of the first heat dissipation layers 416 may be less than a number of the second electrode layers 116.

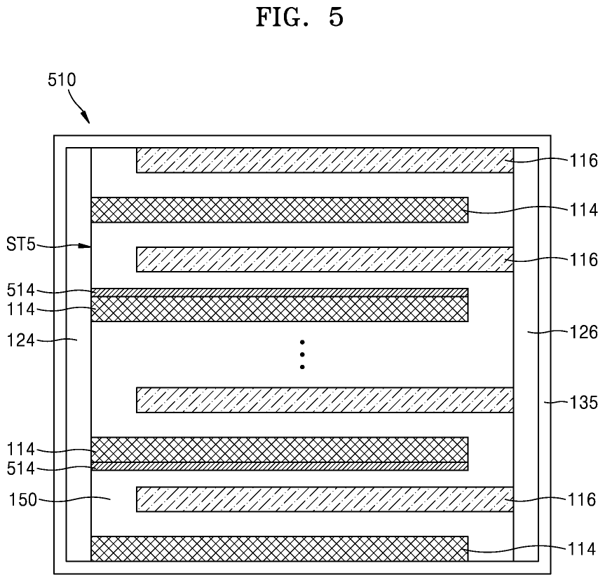

FIG. 5 shows an embodiment of a fifth multilayer ceramic battery 510 including an all-solid electrolyte. Only parts different from the fourth multilayer ceramic battery 410 will be described.

The fifth multilayer ceramic battery 510 may be an embodiment opposite to the fourth multilayer ceramic battery 410.

Specifically, as shown in FIG. 5, a fifth cell stack ST5 of the fifth stacked battery 510 includes a separate second heat dissipation layer 514 on a surface of the first electrode layer 114 instead of having a heat dissipation electrode layer. Accordingly, in the fifth cell stack ST5, each first electrode layer of the plurality of first electrode layers 114 may include the same material with one another, and each second electrode layer of the plurality of second electrode layers 116 may include the same material with one another. In an aspect, the second heat dissipation layer 514 may be disposed on an upper surface of the first electrode layer 114, or on an opposite lower surface of the first electrode layer 114.

In an embodiment, the second heat dissipation layer 514 may be provided to cover a portion or an entirety of the upper surface or the lower surface of the first electrode layer 114 facing the second electrode layer 116. In an aspect, the second heat dissipation layer 514 may face the second electrode layer 116 of the same unit cell. In an aspect, the second heat dissipation layer 514 may face the second electrode layer 116 of an adjacent unit cell. The second heat dissipation layer 514 may be provided in direct contact with the upper surface or the lower surface of the first electrode layer 114. In an embodiment, a thickness of the second heat dissipation layer 514 may be the same as or different from a thickness of the first electrode layer 114. In an embodiment, the material of the second heat dissipation layer 516 may include Al₂O₃, BN, Si₂N₄, SiO₂, AlN, MgO, SiC, C, glass, a metal, or a combination thereof. Because the second heat dissipation layer 514 is inside the fifth cell stack ST5, it may be referred to as an internal heat dissipation layer.

In an embodiment, two or more second heat dissipation layers 514 may be provided in the fifth cell stack ST5, but a number of the second heat dissipation layers 514 may be less than that of the first electrode layers 114.

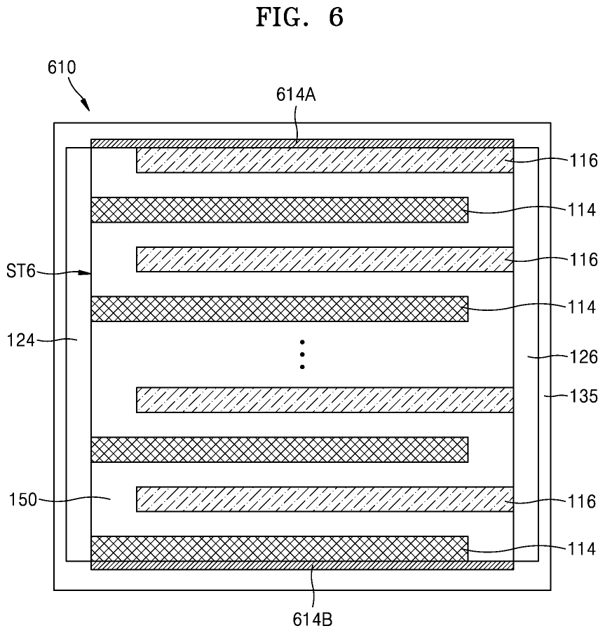

FIG. 6 shows an embodiment of a sixth multilayer ceramic battery 610 including an all-solid electrolyte.

As shown in FIG. 6, internal heat dissipation layers 614A and 614B are provided between the battery case 135 and a sixth cell stack ST6, and a heat dissipation layer may not be provided inside the sixth cell stack ST6.

Specifically, the first inner heat dissipation layer 614A is provided between the case 135 and an upper end of the sixth cell stack ST6, and the second inner heat dissipation layer 614B is provided between the case 135 and a lower end of the sixth cell stack ST6, but only one of the first and the second internal heat dissipation layers 614A and 614B may be provided. In an embodiment, a material of the first and the second internal heat dissipation layers 614A and 614B may be the same as the material of the first and the second heat dissipation layers 416 and 516 of FIGS. 4 and 5, but may be different from each other.

The first to sixth multilayer ceramic batteries 110, 210, 310, 410, 510, and 610 described above may be combined with each other.

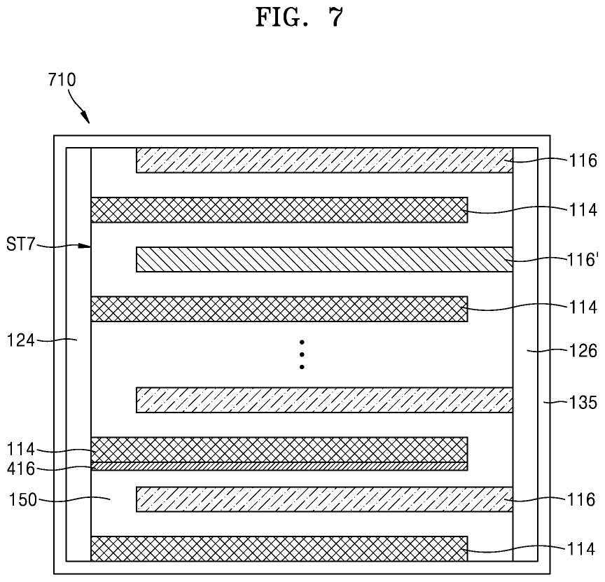

In an embodiment, in a seventh multilayer ceramic battery 710 shown in FIG. 7, the second heat dissipation electrode layer 116′ and the first heat dissipation layer 416 are provided in a seventh cell stack ST7.

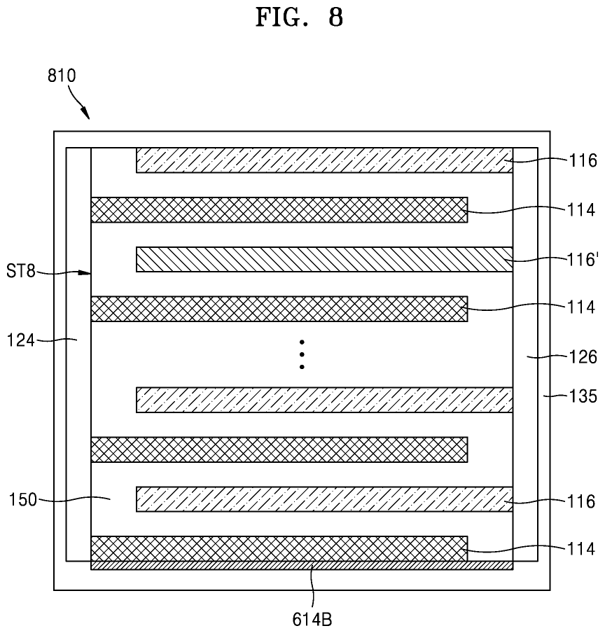

In an embodiment, an eighth multilayer ceramic battery 810 shown in FIG. 8 is a case in which the second heat dissipation electrode layer 116′ and the second internal heat dissipation layer 614B are provided in an eighth cell stack ST8.

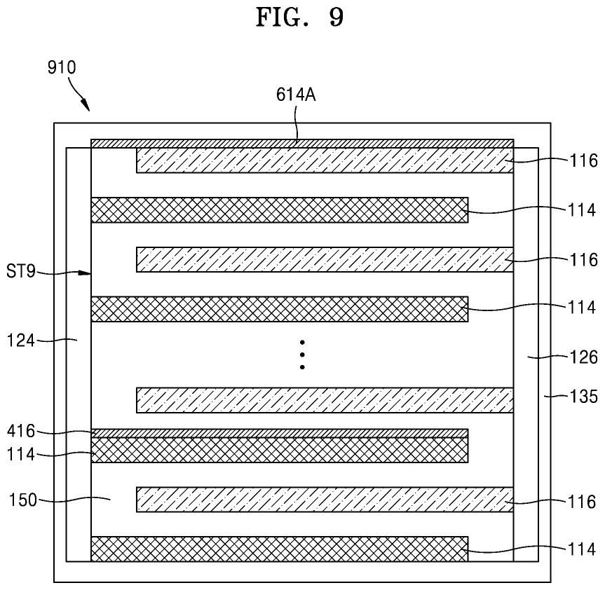

In an embodiment, a ninth multilayer ceramic battery 910 shown in FIG. 9 is a case in which the first heat dissipation layer 416 and the first internal heat dissipation layer 614A are provided in a ninth cell stack ST9.

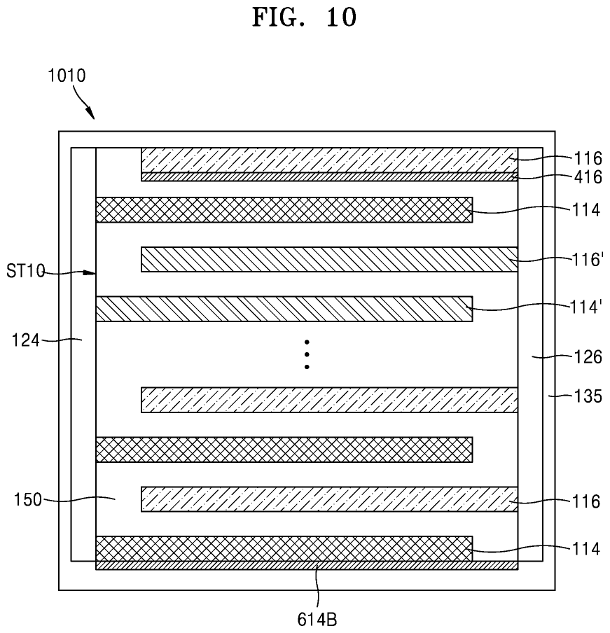

In an embodiment, a tenth multilayer ceramic battery 1010 shown in FIG. 10 is a case in which the first heat dissipation electrode layer 114′, the first heat dissipation layer 416, and the second internal heat dissipation layer 614B are provided in a tenth cell stack ST10.

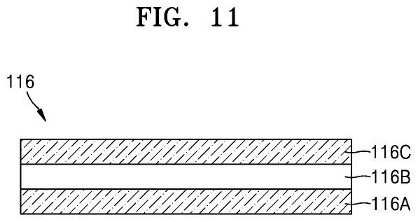

In an embodiment, the first and/or second electrode layers 114 and 116 may have a layer structure including a plurality of layers. In an embodiment, as shown in FIG. 11, the second electrode layer 116 may include sequentially stacked first to third layers 116A, 116B, and 116C, but is not limited thereto. Any one of the first to the third layers 116A, 116B, and 116C, for example, the second layer 116B may be a heat dissipation layer. When the second electrode layer 116 has such a layer structure, the first electrode layer 114 may have a single layer or a plurality of layers.

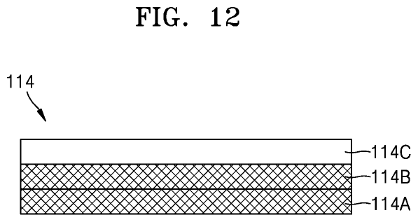

In an embodiment, as shown in FIG. 12, the first electrode layer 114 may have a layer structure including sequentially stacked first to third layers 114A, 114B, and 114B, but is not limited thereto. Any one of the first to the third layers 114A, 114B, and 114C, for example, the third layer 114C may be a heat dissipation layer. When the first electrode layer 114 has such a layer structure, the second electrode layer 116 may have a single layer or a plurality of layers.

The layer structure of the second electrode layer 116 of FIG. 11 and/or the layer structure of the first electrode layer 114 shown in FIG. 12 may be applied to the multilayer ceramic batteries 110, 210, 310, 410, 510, 610, 710, 810, 910, and 1010 illustrated in FIGS. 1 to 10.

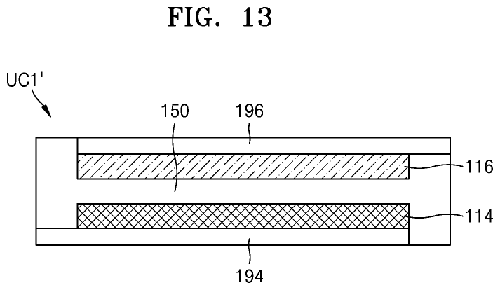

FIG. 13 shows an embodiment of a unit cell UC1′ included in a cell stack of a multilayer ceramic battery according to an embodiment.

Referring to FIG. 13, the unit cell UC1′ includes a first current collector layer 194, the first electrode layer 114, the all-solid electrolyte layer 150, the second electrode layer 116, and a second current collector layer 196 sequentially stacked. In an embodiment, any one of the first and the second current collector layers 194 and 196 may serve as a heat dissipation layer, and in this case, materials of the first and the second current collector layers 194 and 196 may be different from each other. In an embodiment, when the first current collector layer 194 also serves as a heat dissipation layer, the material of the first current collector layer 194 may include Al₂O₃, BN, Si₂N₄, SiO₂, AlN, MgO, SiC, C, glass, a metal, or a combination thereof.

The layer configuration of the unit cell UC1′ illustrated in FIG. 13 may also be applied to the unit cell UC1 of the multilayer ceramic batteries 110, 210, 310, 410, 510, 610, 710, 810, 910, and 1010 illustrated in FIGS. 1 to 10.

In an embodiment, the layer structure of the first electrode layer 114 and the second electrode layer 116 illustrated in FIGS. 11 and 12 may also be applied to the first electrode layer 114 and the second electrode layer 116 of the unit cell UC1′ of FIG. 13, and in this case, the first and the second current collector layers 194 and 196 may not serve as heat dissipation layers.

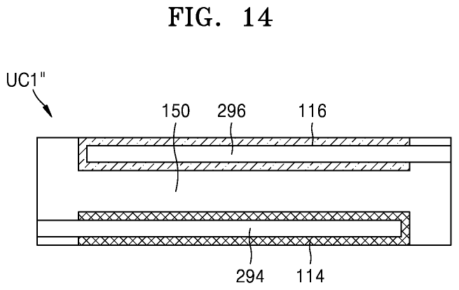

FIG. 14 shows an embodiment of a unit cell UC1″ included in a cell stack of a multilayer ceramic battery according to an embodiment.

Referring to FIG. 14, the unit cell UC1″ includes the first electrode layer 114, the all-solid electrolyte layer 150, and the second electrode layer 116 sequentially stacked. A portion of a first current collector layer 294 is buried in the first electrode layer 114, and a portion of a second current collector layer 296 is buried in the second electrode layer 116. In other words, the first and the second current collector layers 294 and 296 face each other with the all-solid electrolyte layer 150 therebetween, the first electrode layer 114 is formed on a surface of the first current collector layer 294 to cover a portion of the first current collector layer 294, and the second electrode layer 116 is formed on a surface of the second current collector layer 296 to cover a portion of the second current collector layer 296.

In an embodiment, one of the first and the second current collector layers 294 and 296 may serve as a heat dissipation layer, and in this case, materials of the first and the second current collector layers 294 and 296 may be different from each other. In an embodiment, when the first current collector layer 294 also serves as a heat dissipation layer, a material of the first current collector layer 294 may be the same as or different from that of the first current collector layer 194 of FIG. 13.

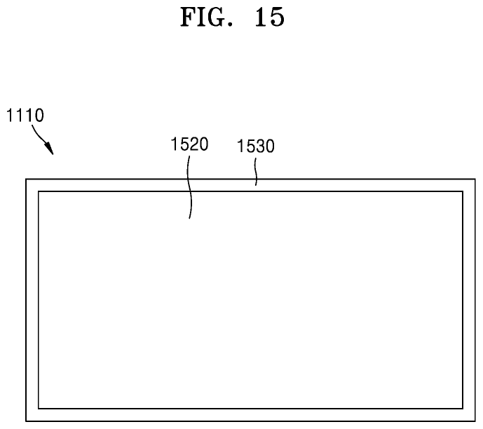

FIG. 15 shows an embodiment of an eleventh multilayer ceramic battery 1110.

Referring to FIG. 15, an eleventh multilayer ceramic battery 1110 includes a battery 1520 and an external heat dissipation layer 1530 surrounding the battery 1520. In an embodiment, the battery 1520 may be one of the first to tenth multilayer ceramic batteries 110, 210, 310, 410, 510, 610, 710, 810, 910, and 1010 described above. In an embodiment, the battery 1520 may be a multilayer battery that does not include a heat dissipation layer therein. In an embodiment, a thickness of the external heat dissipation layer 1530 around the battery 1520 may be uniform or substantially uniform. In an embodiment, a material of the external heat dissipation layer 1530 may be a material having an emission coefficient close to 1, for example, the external heat dissipation layer 1530 may include Al₂O₃, BN, Si₂N₄, SiO₂, AlN, MgO, SiC, C, glass, a metal, or a combination thereof.

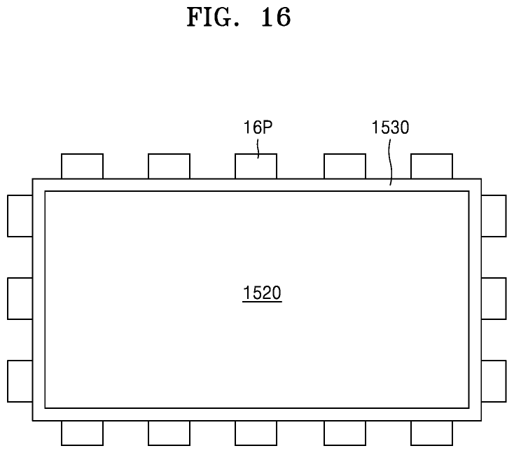

FIG. 16 is an embodiment in which a plurality of first protrusions 16P are provided on a surface of the external heat dissipation layer 1530 of FIG. 15. The plurality of first protrusions 16P may be uniformly distributed on the surface of the external heat dissipation layer 1530, but may be formed with a high density in a region where heat dissipation is relatively severe. In an embodiment, the first protrusions 16P may have a three-dimensional shape, for example, a quadrangular pillar shape, but is not limited to this shape. In an embodiment, the first protrusions 16P may have a cylindrical shape.

In an embodiment, a material of the first protrusions 16P and a material of the external heat dissipation layer 1530 may be the same as or different from each other.

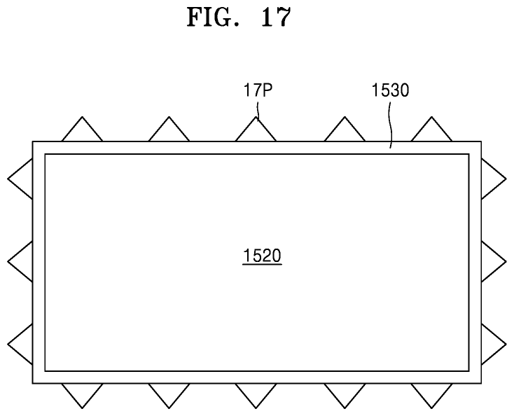

FIG. 17 shows an embodiment in which a plurality of second protrusions 17P are provided on the surface of the external heat dissipation layer 1530 of FIG. 15. The second protrusions 17P may have a shape different from that of the first protrusion 16P.

For example, the second protrusions 17P may have a three-dimensional shape and may have a triangular cross section. For example, the second protrusions 17P may have a triangular pyramid shape or a pyramid shape.

A distribution of the second protrusions 17P on the external heat dissipation layer 1530 may be the same as or substantially the same as a distribution of the first protrusions 16P. In an embodiment, a material of the second protrusions 17P may be the same as or different from that of the first protrusions 16P.

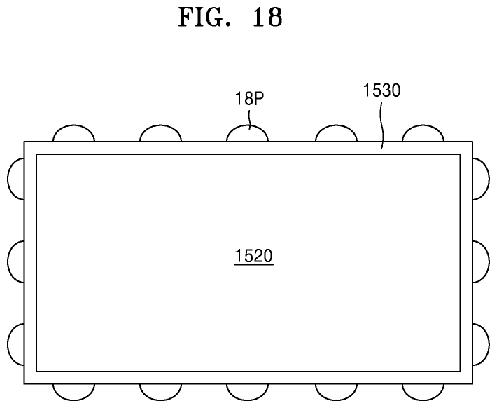

FIG. 18 shows an embodiment in which a plurality of third protrusions 18P are provided on the surface of the external heat dissipation layer 1530 of FIG. 15. The third protrusions 18P may have a different shape from the first and the second protrusions 16P and 17P.

The third protrusions 18P may also have a three-dimensional shape, and may have, for example, a spherical surface. A distribution of the third protrusions 18P on the external heat dissipation layer 1530 may follow the distribution of the first protrusions 16P, but may be distributed differently. In an embodiment, a material of the third protrusions 18P may be the same as or different from that of the first protrusions 16P.

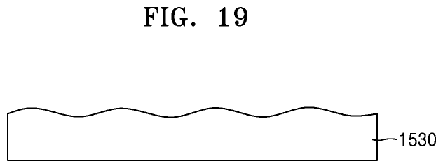

In an embodiment, as shown in FIG. 19, a surface of the external heat dissipation layer 1530 may have a wave structure.

In an embodiment, in the multilayer ceramic batteries illustrated in FIGS. 15 to 19, a portion of the external heat dissipation layer 1530 may be a first material layer, and a remaining portion of the external heat dissipation layer 1530 may include a second material layer, which is different from the first material layer. In an aspect, a heat release coefficient of the first material layer and a heat release coefficient of the second material layer are different from each other.

As shown in FIGS. 16 to 19, the surface of the external heat dissipation layer 1530 is not flat, that is, a wrinkle exists on the surface of the external heat dissipation layer 1530, a surface area per unit area of the external heat dissipation layer 1530 is increased, and thus, an apparent heat dissipation coefficient of the external heat dissipation layer 1530 may be greater than about 1. In an aspect, the wrinkle may be on a major surface of the external heat dissipation layer 1530.

The multilayer ceramic battery according to an embodiment described above is a secondary battery and may be applied to various devices using a battery as a power source. Here, the device may include an electronic apparatus.

One of the first to the eleventh stacked batteries 110, 210, 310, 410, 510, 610, 710, 810, 910, 1010, and 1110 described above may be a smart phone, a wearable device (e.g., a watch, a band, a light, a biosignal detector, an earphone, a headset, an audio device, etc.), an augmented reality (AR) and virtual reality (VR) device, an Internet of Things (IOT) device, a home appliance, a tablet PC (Personal Computer), a Personal Digital Assistants (PDA), a portable multimedia player (PMP), a navigation, a drone, a robot, an unmanned car, a self-driving car, an advanced driver assistance system (ADAS), etc., but are not limited thereto.

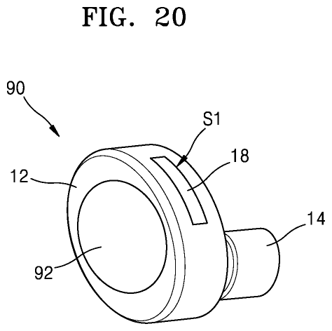

FIG. 20 shows a battery replaceable wireless earbud 90 as an example of an electronic apparatus including a secondary battery according to an embodiment.

Referring to FIG. 20, an earbud 90 includes a body 12 and an insertion part 14 connected thereto. The body 12 may include a circuit board that supports the operation of the earbud 90 and manages a battery. The insertion unit 14 has a structure protruding by a first length to a given direction from a surface of the body 12, and is a portion inserted into an ear of the earbud 90 wearer. The first length may be determined in consideration of a depth of the wearer's ears. A slot S1 is formed in the body 12. An inlet of the slot S1 may be formed on the surface of the body 12. A battery 18 is inserted into the slot S1. The battery 18 may be a secondary battery that may be recharged and used repeatedly. In an embodiment, the battery 18 may include one of the above-described first to eleventh stacked batteries 110, 210, 310, 410, 510, 610, 710, 810, 910, 1010, and 1110. The battery 18 may be a coin-shaped or square shaped secondary cell. The slot S1 may have a rectangular shape, but may have a shape suitable for the shape of the battery 18, that is, a shape optimized for mounting the battery 18.

Reference numeral 92 is a switch (operation button) for turning on and off the operation of the earbud 90. The switch 92 may be operated by a touch method including a touch sensor.

The earbud 90 may be a wireless earphone and may be an AirPod.

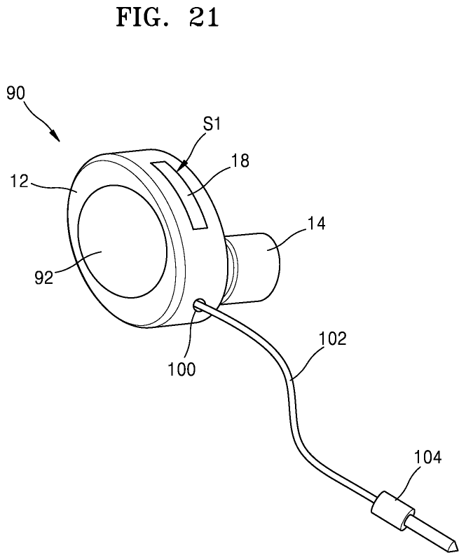

In an embodiment, as shown in FIG. 21, the earbud 90 may further include a connection cable 102 and may be used for both wired and wireless purposes. The connection cable 102 connects the earbud 90 to an external device (not shown). The external device may be a device that provides audio information or audio signals to be heard through the earbud 90, and may be, for example, a mobile device, a video supply medium, or a radio.

One end of the cable 102 is connected to the earbud 90. A jack 104 is attached to the other end of the cable 102. The jack 104 may be inserted into an insertion hole provided in a device. The earbud 90 has a groove 100 for connecting the cable 102 to a portion of the body 12 to which one end of the cable 102 is connected. Although the cable 102 may be permanently connected to the body 12 through the groove 100, a jack may be provided at one end of the cable 102 similar to the other end and inserted into the groove 100. In the latter case, the cable 102 may be disconnected from the earbud 90 and the device. Therefore, when the cable 102 is not needed, such as outdoors, earbud 90 may be used as a wireless earbud that does not use the cable 102. For indoor use, by using the earbud 90 in a wired manner using the cable 102, the battery may be kept in a charged state.

The earbud 90 shown above is only one of a paired earbud, for example, the earbud for the user's left ear. The configuration of the earbud for the user's right ear may also be identical to that of the earbud for the left ear.

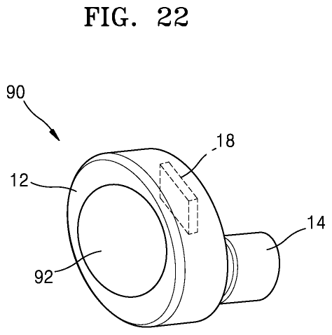

In the earbud 90 of FIGS. 20 and 21, the slot S1 may be an optional configuration. For example, as shown in FIG. 22, the earbud 90 may not have the slot S1, and the battery 18 may be included in the body 12.

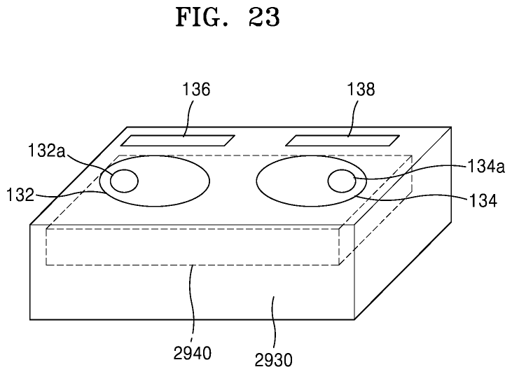

FIG. 23 shows a case for storage and charging of the earbuds illustrated in FIGS. 20 to 22.

Referring to FIG. 23, first and second grooves 132 and 134 are formed on an upper surface of a case 2930. Earbuds are mounted in the first and the second grooves 132 and 134, respectively. A third groove 132a having a depth greater than the first groove 132 is formed in the first groove 132. A fourth groove 134a having a depth greater than the second groove 134 is formed in the second groove 134. The third and the fourth grooves 132a and 134a may be grooves into which the insertion unit 14 of the earbud is inserted. The third and the fourth grooves 132a and 134a may be through holes. First and second slots 136 and 138 are formed on an upper surface of the case 2930. The first and the second slots 136 and 138 may be adjacently disposed to correspond to the first and the second grooves 132 and 134, respectively. The first and the second slots 136 and 138 are slots for battery charging. While storing the earbuds in the first and the second grooves 132 and 134, the batteries may be charged by inserting the batteries into the first and the second slots 136 and 138. Inside the case 2930, a large-capacity power supply source 2940 is disposed. Batteries inserted into the first and the second slots 136 and 138 may be charged from a large-capacity power supply source 2940. The large-capacity power supply source 2940 may be, for example, a large-capacity battery.

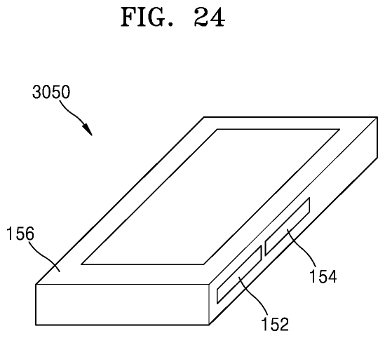

FIG. 24 shows an embodiment of a mobile device 3050 dedicated to the earbud 90 shown in FIG. 20.

Referring to FIG. 24, a mobile device 3050 compatible with the earbuds may be a mobile device optimized for the earbuds. The mobile device 3050 may be a mobile phone or other portable image providing device. The mobile device 3050 includes a body 156 having a terminal for outputting at least an audio signal (voice information) and/or an image signal (image information) and first and second slots 152 and 154 on a side surface of the body 156. The first and the second slots 152 and 154 may be slots for charging replacement batteries of the earbuds. Charging power of the battery may be supplied from power of the mobile device 3050.

The disclosed multilayer ceramic battery including an all-solid electrolyte layer has a heat dissipation layer inside a cell stack and/or on a surface of the multilayer ceramic battery. Accordingly, heat generated during charging and/or discharging of the multilayer ceramic battery may be effectively dissipated, and accordingly, overheating of the multilayer ceramic battery may be prevented and stable battery operation and charging/discharging efficiency may be ensured while extending a battery life.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A multilayer ceramic battery comprising:
a cell stack comprising a plurality of unit cells;
a first external current collector layer disposed on a first side surface of the cell stack;
a second external current collector layer disposed on a second side surface of the cell stack;
a case surrounding the cell stack, the first external current collector layer, and the second external current collector layer; and
a heat dissipation layer configured to dissipate heat generated from the cell stack to the outside, wherein the heat dissipation layer is disposed in a region surrounded by the case.

2. The multilayer ceramic battery of claim 1, wherein the heat dissipation layer is disposed inside the cell stack.

3. The multilayer ceramic battery of claim 1, wherein the heat dissipation layer is disposed between the cell stack and the case.

4. The multilayer ceramic battery of claim 2, wherein the heat dissipation layer is disposed in a unit cell of the plurality of unit cells.

5. The multilayer ceramic battery of claim 4, wherein the unit cell comprises a first electrode layer;
a second electrode layer disposed to face the first electrode layer; and
an all-solid electrolyte layer disposed between the first electrode layer and the second electrode layer,
wherein the heat dissipation layer is disposed between the first electrode layer and the all-solid electrolyte layer, between the second electrode layer and the all-solid electrolyte layer, or a combination thereof.

6. The multilayer ceramic battery of claim 4, wherein the unit cell comprises
a first electrode layer;
a second electrode layer disposed to face the first electrode layer; and
an all-solid electrolyte layer disposed between the first electrode layer and the second electrode layer,
wherein
the first electrode layer and the second electrode layer are current collector layers,
one of the first electrode layer and the second electrode layer is the heat dissipation layer, and
a heat release coefficient of the first electrode layer and a heat release coefficient of the second electrode layer are different from each other.

7. The multilayer ceramic battery of claim 4, wherein the unit cell comprises:
a first electrode layer;
a first internal current collector layer in contact with the first electrode layer;
a second electrode layer disposed to face the first electrode layer;
a second internal current collector layer in contact with the second electrode layer; and
an all-solid electrolyte layer between the first electrode layer and the second electrode layer, and between the first internal current collector layer and the second internal current collector layer,
wherein one of the first internal collector layer and the second internal collector layer is the heat dissipation layer, and
a heat release coefficient of the first internal collector layer and a heat release coefficient of the second internal current collector layer are different from each other.

8. The multilayer ceramic battery of claim 7, wherein only one surface of the first electrode layer is in contact with the first internal current collector layer, and only one surface of the second electrode layer is in contact with the second internal current collector layer.

9. The multilayer ceramic battery of claim 7, wherein the first electrode layer is disposed on both sides of the first internal current collector layer, and
the second electrode layer is disposed on both sides of the second internal current collector layer.

10. The multilayer ceramic battery of claim 4, wherein the unit cell comprises:
a first electrode layer;
a second electrode layer disposed to face the first electrode layer; and
an all-solid electrolyte layer disposed between the first electrode layer and the second electrode layer,
wherein one of the first electrode layer and the second electrode layer comprises the heat dissipation layer.

11. The multilayer ceramic battery of claim 10, wherein one of the first electrode layer and the second electrode layer comprises a stack comprising a plurality of material layers, and
at least one of the plurality of material layers is the heat dissipation layer.

12. The multilayer ceramic battery of claim 1, further comprising an external heat dissipation layer on an outer surface of the case.

13. The multilayer ceramic battery of claim 12, wherein a surface of the external heat dissipation layer comprises a wrinkle.

14. The multilayer ceramic battery of claim 13, wherein the surface of the external heat dissipation layer comprises a plurality of protrusions.

15. The multilayer ceramic battery of claim 13, wherein a portion of the external heat dissipation layer comprises a first material layer, and a remaining portion of the external heat dissipation layer comprises a second material layer,
wherein a heat release coefficient of the first material layer and a heat release coefficient of the second material layer are different from each other.

16. A multilayer ceramic battery comprising:
a cell stack including a plurality of unit cells;
a first external current collector layer disposed on a first side surface of the cell stack;
a second external current collector layer disposed on a second side surface of the cell stack;
a case surrounding the cell stack, the first external current collector, and the second external current collector; and
an external heat dissipation layer disposed on an outer surface of the case,
wherein the external heat dissipation layer comprises a wrinkle on a surface thereof.

17. The multilayer ceramic battery of claim 16, wherein the external heat dissipation layer comprises a plurality of protrusions on the surface of the external heat dissipation layer.

18. The multilayer ceramic battery of claim 16, wherein a portion of the external heat dissipation layer comprises a first material layer, and a remaining portion of the external heat dissipation layer comprises a second material layer,
wherein a heat release coefficient of the first material layer and a heat release coefficient of the second material layer are different from each other.

19. An electronic apparatus comprising:
a controller for controlling an operation of a device; and
a battery,
wherein the battery comprises the multilayer ceramic battery of claim 1.

20. The electronic apparatus of claim 19, wherein the electronic apparatus is a wearable device.
